(19) United States
(12) Patent Application Publication
(10) Pub. No.: US 2014/0074710 A1
(43) Pub. Date: Mar. 13, 2014

(54) Consumer Processing of Payments for Merchants

(71) Applicant: Arunachalam Muthu, Fremont, CA (US)

(72) Inventor: Arunachalam Muthu, Fremont, CA (US)

(73) Assignee: eBay, Inc., San Jose, CA (US)

(21) Appl. No.: 13/613,944

(22) Filed: Sep. 13, 2012

(51) Int. Cl. G06Q 20/40

(52) U.S. Cl. 705/44

(57) ABSTRACT

Methods and systems are provided for facilitating payment to a merchant for products purchased by a customer. A merchant identification card of the merchant can be swiped on a user device to facilitate such payment. Thus, the payment can be made in a manner that does not compromise personal information of the user to the merchant or to others. The user does not have to be concerned with receiving unwanted advertisements or with other problems associated with such undesirable disclosure of the user's personal information.

### BACKGROUND

1. Technical Field

The present disclosure generally relates to electronic commerce and, more particularly, relates to a method and system for facilitating payment processing by a customer, such as within a store.

2. Related Art

Purchases from a merchant at a brick-and-mortar store are commonly paid for with a credit card. Typically, a customer selects products to be purchased, waits in line at a checkout counter, waits while a checkout clerk scans the products, gives the credit card to the checkout clerk for scanning or scans the credit card herself, waits for authorization from the credit card company, signs for the purchase, waits while the purchased products are bagged, and finally leaves the store with the purchased products.

This procedure is generally acceptable, especially as long as the merchant keeps enough checkout counters open such that the checkout lines stay short. However, this procedure does suffer from substantial deficiencies. Even when the checkout lines are short and the checkout clerk is quick, the wait can be objectionable, particularly if the customer is in a hurry.

Further, when the customer provides the merchant with the customer's credit card, the customer inherently provides the merchant with a substantial amount of personal information. For example, by using the credit card the customer can provide the merchant, either directly or indirectly, with the customer's name, credit card number, home address, email address, texting number, telephone number, social media information, and credit information.

Some of this information is on the credit card itself. For example, the customer's name and credit card number are generally on credit cards. Some of this information can be obtained from the customer. For example, the merchant may ask the customer for a phone number and/or address as a requirement for allowing use of the credit card. Some of this information can be obtained indirectly by correlation with various databases. For example, once the person's name and credit card number are known, the merchant or others can access various credit, marketing, and other databases to obtain the customer's address, telephone number, credit profile, and other information.

The merchant and others to whom the merchant has sold the information also know what products the customer purchased. The merchant or others to whom the merchant has sold the information can easily target advertising to the customer. However, the customer may not want to be recipient of such advertising. Also, the customer may want to limit the availability of such information to others for various security related reasons.

### BRIEF DESCRIPTION OF THE DRAWINGS

FIG. 1 is a block diagram of a system for customer payment processing, according to an embodiment;

FIG. 2 is a user device suitable for use in the system for customer payment processing, according to an embodiment;

FIG. 3 is a credit card reader of the user device of FIG. 2, according to an embodiment;

FIG. 4 is a block diagram of an example of a computer that is suitable for use in the system for customer payment processing, according to an embodiment.

FIG. 5 is a flow chart showing a method for customer payment processing, according to an embodiment; and

FIG. 6 is a flow chart showing further detail of the method for customer payment processing, according to an embodiment.

### DETAILED DESCRIPTION

When a customer or user provides a merchant with the user's credit card in order to make a purchase, the user potentially provides the merchant and others with a substantial amount of personal information. The merchant can directly obtain the user's name and credit card number from the credit card. The merchant can require that additional personal identification be provided. The merchant and others can obtain, via the use of various databases (such as credit databases and marketing databases), other information regarding the user. For example, the merchant and others may be able to obtain the user's home address, email address, texting number, telephone number, social media information, and/or credit profile. The use of checks and other types of cards, e.g., debit cards and gift cards, present similar problems.

From the purchase transaction, the merchant also knows what products the customer purchased. The merchant and others can use the information for various reasons. For example, the merchant can sell the information to others, such as other merchants, who can then use the information to provide targeted advertising to the customer. Such selling of the information by the merchant to others can be done without the user's awareness or permission.

The user can be exposed to unwanted advertising via regular mail, email, texting, telephone, and social media, for example. The merchant or others can send the user advertisements for products for which it is assumed that the user has some interest based upon the user's credit card purchase. For example, if the user purchased a baseball glove, then the user can be inundated with advertisements for sporting goods, sports memorabilia, sporting event tickets, cable sports packages, and the like. In many instances, the user may not want to receive such unsolicited advertising.

Moreover, the user may not want such personal information being distributed and used to provide targeted advertising to the user. The user may not want such personal information being given to others (including the merchant from whom the user made the purchase) at all. Such distribution of the information not only exposes the user to unwanted advertising, but can also potentially expose the user to harm.

The user may not want such personal information being distributed and used by others for various security related reasons. Such information can be used to harm the user, such as is far too common in cases of fraud and theft. The information can be used to purchase products, open bank accounts, and withdraw money in the name of the user. For example, a credit card number can be sold by an unscrupulous merchant to a criminal who makes fraudulent purchases with the credit card. The bill for such purchases is then sent by the credit card company to the user. Often, it takes the user a substantial amount of time, money, and effort to resolve such problems. Banks and credit card companies can be slow to respond. Sometimes such matters are never resolved to the satisfaction of the user.

The information can even be used to facilitate a burglary of the user's home. When the products being purchased by the user indicate that the user is well-to-do, the information can readily be used by criminals to target the user's home for a break-in robbery. Of course, such a robbery seriously jeopardizes the user and the user's family. Loss of money and valuable property (such as jewelry, collectable coins, artwork, etc.) can result from such a robbery. Occupants of the house can be injured or killed.

Thus, there are many reasons for not providing personal information to strangers, such as by using a credit card to make a purchase. Because of such reasons, many customers find it objectionable to provide merchants with such information. Therefore, such customers are hesitant to use credit cards to make purchases.

Methods and systems are provided for facilitating payment to a merchant for products purchased by a user, according to an embodiment. A card of the merchant, such as a payment receiving card or a merchant identification card can be swiped, scanned, photographed, or otherwise read via a user device to facilitate such payment. By photographing the merchant identification card, such as with a camera of a cellular telephone, the need for an accessory or dongle for the cellular telephone is eliminated.

Information from the merchant identification card can be entered manually. For example, the user can key in the information using a keyboard of the user device.

Alternatively, the user can enter the information into the user device via voice recognition. The information can include a merchant identification card number, for example. The information can be provided to the user in any desired manner and does not have to be presented to the user upon the merchant identification card. For example, the information can be displayed for the user, such as on a sign or a monitor.

The user's credit card (if the user has a credit card) is not provided to the merchant. No information regarding the user needs to be provided to the merchant. Thus, the payment can be made in a manner that does not compromise personal information of the user to the merchant or to others. The user does not have to be concerned with receiving unwanted advertisements or with other problems associated with such undesirable disclosure of the user's personal information.

The method can be thought of, at least to some degree, as somewhat the reverse of a contemporary credit card transaction. Rather than the user giving the merchant the user's credit card to swipe, instead the merchant gives the user a card (the merchant identification card) to swipe, scan, photograph, or otherwise read. The user can swipe, scan, photograph, or otherwise read the merchant identification card with a portable credit card reading device, such as a user's mobile device. A payment provider, such as Paypal, Inc., can use information from the merchant's swiped merchant identification card (which identified the merchant) and information from the user's mobile device (which identifies the user) to facilitate the payment transaction.

According to an embodiment, a system can comprise a memory storing account information of a user in a user account and storing account information of a merchant in a merchant account. One or more processors can be operable to receive a first communication from the user including information regarding the user (such as the user's identification or account number), an indication of a desire of the user to pay for one or more products of the merchant, and including information from a merchant identification card of the merchant (such as the merchant's identification or account number). The processor(s) can access the user account. The processor(s) can determine, at least in part from the account information of the user, if the user is authorized to purchase the products. The processor(s) can authorize a payment transaction if the user is authorized to purchase the products.

The first communication can include information from the merchant identification card and a total price for the products being purchased. The total price can be the price of all of the products added together plus any other amounts owed, such as state sales tax.

Information stored on the merchant identification card can include an identification of the merchant. For example, information stored on the merchant identification card can include a merchant account number and a merchant identification card expiration date. This information can be provided to the user device when the merchant identification card is swiped.

The processor(s) can be further operable to transfer money from the user account to the merchant account. In this manner, the processor(s) can effect payment to the merchant for products purchased by the user.

The processor(s) can be further operable to send a second communication to the merchant and/or to the user including an indication that the payment transaction has been authorized or completed. The second communication can be an email, text message, payment alert or any other type of message. Thus, the merchant can be assured that payment will be received from the user for the products purchased and the merchant can thus allow the user to leave the store with the products.

According to an embodiment, a method can comprise storing, in a memory, account information of a user in a user account and account information of a merchant in a merchant account. The method can further comprise receiving, electronically via the processor(s), a first communication from the user including an indication of a desire of the user to pay for a product of the merchant and including information from a merchant identification card of the merchant. The method can further comprise accessing, via the processor(s), the user account. The method can further comprise determining, via the processor(s) and at least in part from the account information of the user, if the user is authorized to purchase the product. The method can further comprise authorizing, via the processor(s), a payment transaction if the user is authorized to purchase the product.

According to an embodiment, a computer program product can comprise a non-transitory computer readable medium having computer readable and executable code. The computer program product can instruct the processor(s) to perform the method discussed herein.

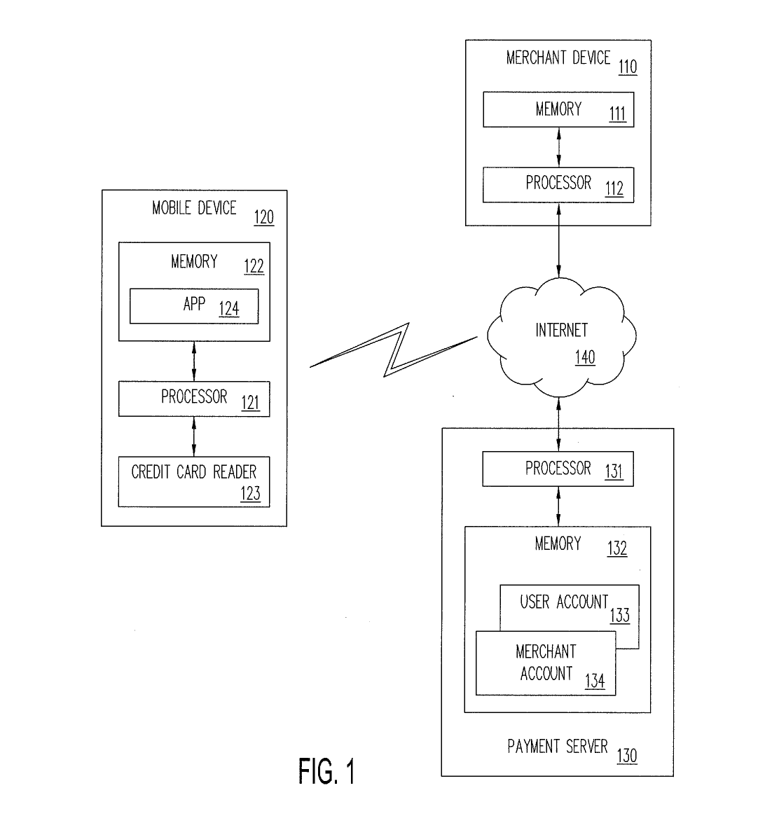

FIG. 1 is a block diagram of a system for customer payment processing, in accordance with an embodiment. The system can include a merchant device 110. The merchant device 110 can be a merchant checkout terminal, a computer, and/or a server, for example. The merchant device 110 can include a memory 111 and a processor 112. The merchant device 110 can be used to ring up, e.g., total, the user's purchases, for example.

The system can include a mobile device 120. The mobile device 120 can be carried by the user. The mobile device 120 can be a cellular telephone, a smart telephone, a hand held computer, a laptop computer, a notebook computer, or a tablet computer, for example. The mobile device 120 can include a processor 121, a memory 122, and a credit card reader 123. The credit card reader 123 can be a cellular telephone accessory or dongle. The memory 122 can contain an app 124. Thus, the user device 120 can define a mobile or portable credit card reader with the capability to communicate with a payment provider, credit card company, bank, or other financial entity.

The system can include a payment server 130. The payment server 130 can be a server of a payment provider, such as Paypal, Inc. The payment server 130 can be a single server or can be a plurality of servers. The payment server 130 can include one or more processors 131 and a memory 132. The memory 132 can be a memory of the payment server 130 or a memory that is associated with the payment server 130. The memory 132 can be a distributed memory. The memory 132 can store a user account 133 and a merchant account 134.

The merchant device 110, the mobile device 120, and the payment server 130 can communicate with one another via a network, such as the Internet 140. The merchant device 110, the mobile device 120, and the payment server 130 can communicate with one another via one or more networks, such as local area networks (LANs), wide area networks (WANs), cellular telephone networks, and the like. The merchant device 110, the mobile device 120, and the payment server 130 can communicate with one another, at least partially, via one or more near field communications (NFC) methods or other short range communications methods, such as infrared (IR), Bluetooth, WiFi, and WiMax.

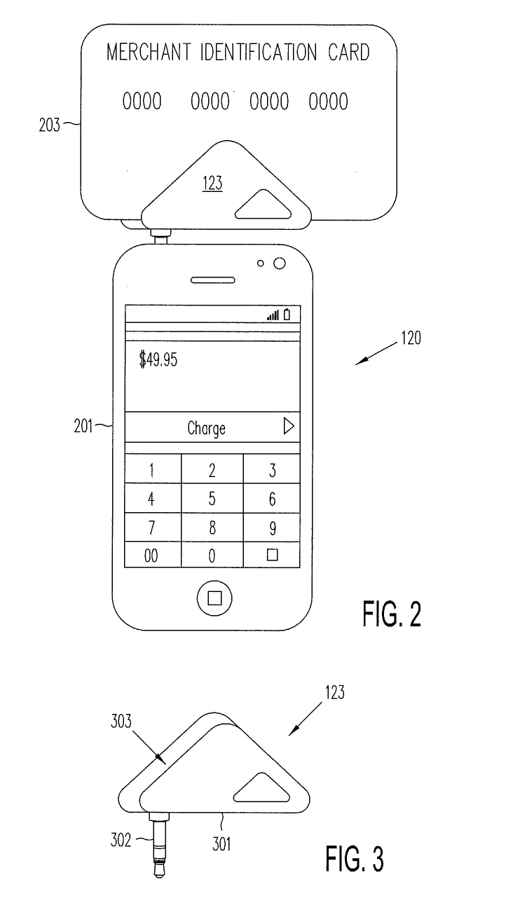

FIG. 2 is an example of the user device 120, according to an embodiment. More particularly, the user device 120 can comprise a cellular telephone 201 and a credit card reader 123. The cellular telephone 201 can be an Apple cellular telephone (such as an iPhone), an Android cellular telephone, or any other type of cellular telephone. The credit card reader 123 can be removably attached to the cellular telephone 201. The credit card reader 123 can be a Paypal Here credit card reader, for example. The credit card reader 123 can be any type of credit card reader. The app 124 stored in the memory 122 of the cellular telephone 201 can cooperate with the cellular telephone 201 and the credit card reader 123 to facilitate swiping or scanning of the merchant's receiving card 203. Thus, together the cellular telephone 201, the credit card reader 213, and the app 122 can define a user mobile device 120 suitable for scanning the merchant's merchant identification card 203 can communicating with the payment server 130 so as to facilitate payment to the merchant for products purchased by the user.

The credit card reader 123 can be suitable for reading credit cards according to well-known principles. The credit card reader 123 can be suitable for reading the merchant's merchant identification card 203 according to the same principles. The merchant's merchant identification card 203 and be similar to a credit card. The merchant's merchant identification card 203 can have the same physical construction as a credit card. The information stored on the magnetic strip of the merchant's merchant identification card 203 can be information regarding the merchant and merchant account 134. The information stored on the magnetic strip of the merchant's merchant identification card 203 can be used to facilitate a transfer of money, such as payment for products purchased, from the user account 133 to the merchant account 134.

The cellular telephone 201 can run the app 124 that facilitates use of the credit card reader 123 to swipe the merchant identification card 203 and that communicates information regarding a payment transaction to the payment server 130. Thus, the user device 120 can be used for customer payment processing, as discussed herein.

FIG. 3 is the credit card reader 123 of the user device 120 of FIG. 2, according to an embodiment. The merchant identification card 203 can comprise a reader 301, and a read slot 303 and a plug 302. The reader 301 can facilitate reading of the magnetic strip of the credit card 203 by swiping the merchant identification card 203, e.g., sliding the merchant identification card 203 through the read slot 303 reader 123. The plug 302 can mechanically and electronically connect the credit card reader 123 to the cellular telephone 201.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Payment processing can be through known methods, such as transaction details being communicated to the payment provider through the app, the payment provider processing the details, which may include user account and identifier information and authentication, merchant information, and transaction details. The user account may be accessed to determine if any restrictions or limitations may prevent the transaction from being approved. If approved, the payment provider may send a notification to the merchant and/or the user.

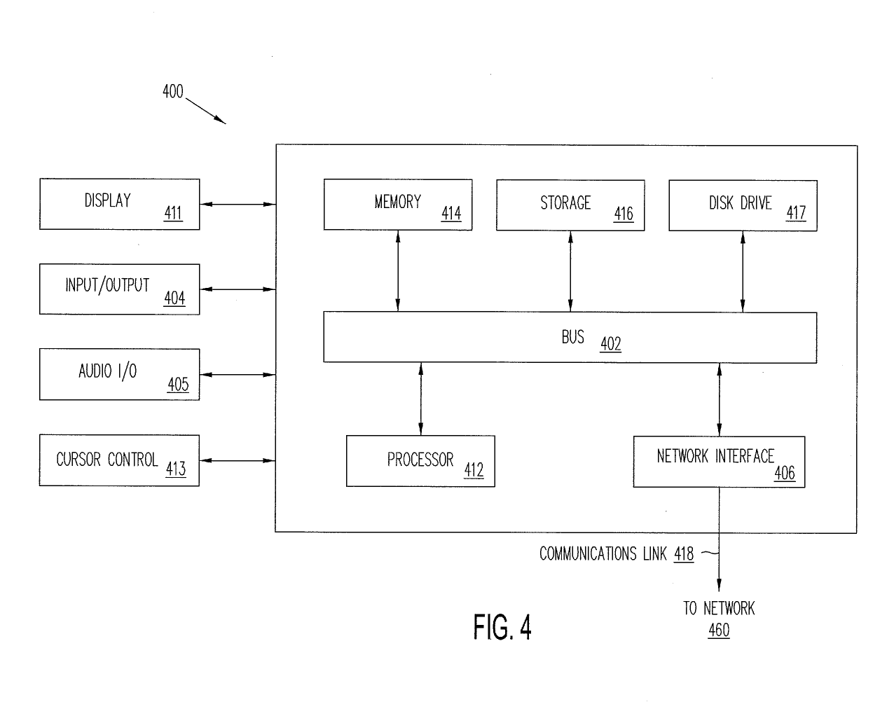

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a mariner as follows. Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

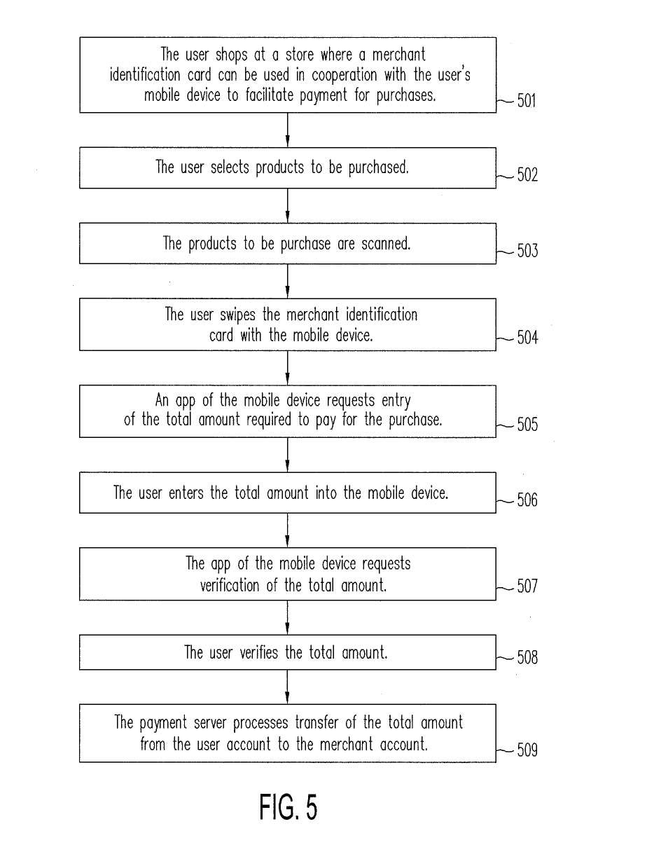

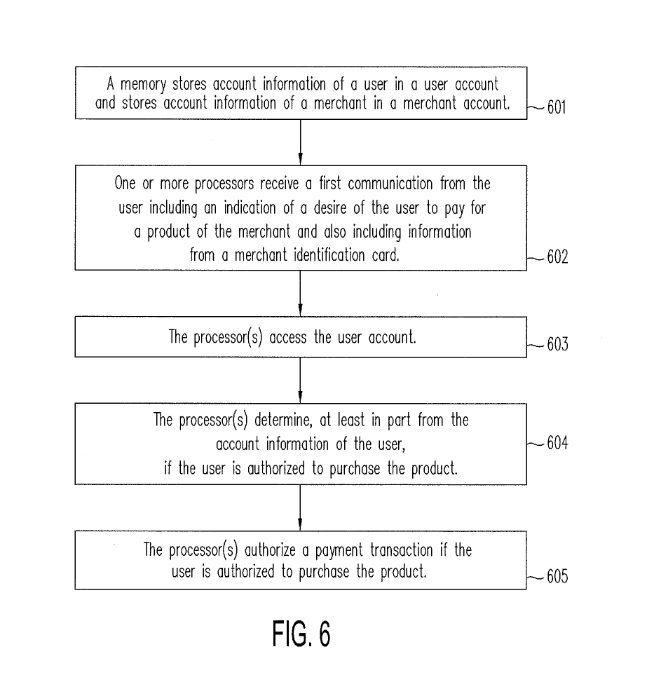

FIGS. 5 and 6 are flow charts that describe examples of operation of the system for customer payment processing according to embodiments thereof. Note that one or more of the steps described herein may be combined, omitted, or performed in a different order, as desired or appropriate.

FIG. 5 is a flow chart showing a method for customer payment processing generally from the user's point of view, according to an embodiment. The user can shop at a store where a merchant's merchant identification card 203 can be used in cooperation with the user's mobile device 120 to facilitate payment for purchases, as shown in step 501. The store can be a brick and mortar store, such as a department store, clothing store, sporting goods store, convenience store, or any other kind of store. The method for customer payment processing can be used at movie theaters, garages, or any other place where goods or services can be purchased.

The store can display a sign, logo, or other indicia that indicates that the user can pay for products via the customer payment processing method discussed herein. For example, the store can display a sign and/or logo for PayPal Here. By accepting payment via the customer payment processing method described herein, the merchant can encourage use of the store by potential customers. Thus, the merchant can potential increase sales by accepting payment via the customer payment processing method described herein.

According to an embodiment, the customer payment processing method described herein can be used with mail order or online merchants. For example, a mail order merchant can mail a merchant identification card 203 for the merchant to the user. The mailed merchant identification card can be similar to a credit card and can have a magnetic strip.

The merchant identification card 203 for the mail order merchant can be a one-time only merchant identification card. That is, the payment server 130, the user device 120, and/or the merchant identification card 203 can be configured to facilitate payment using the merchant identification card 203 from the mail order merchant only one time. Alternatively, the merchant identification card 203 from the mail order merchant can be used a predefined and limited number of times. As a further alternative, the merchant identification card 203 from the mail order merchant can be used an unlimited number of times.

The merchant identification card 203 from the mail order merchant can be configured to be used only by a single user. Alternatively, the merchant identification card 203 from the mail order merchant can be configured to be used by a plurality of users.

As a further example, an online merchant can email a merchant identification card 203 for the merchant to the user. The emailed merchant identification card 203 can be different from a credit card and can have a bar code or a QR (quick response) code rather than a magnetic strip. The emailed merchant identification card can be printed and scanned by the user. Alternatively, the emailed merchant identification card 203 can be a virtual merchant identification card that does not require printing and scanning. Rather, the virtual merchant identification card can merely be communicated to the payment server 130 to facilitate a payment transaction.

The merchant identification card 203 for the online merchant can be a one-time only merchant identification card 203. That is, the payment server 130, the user device 120, and/or the merchant identification card 203 can be configured to facilitate payment using the merchant identification card 203 from the online merchant only one time. Alternatively, the merchant identification card 203 from the online merchant can be used a predefined and limited number of times. As a further alternative, the merchant identification card 203 from the online merchant can be used an unlimited number of times.

The merchant identification card 203 from the online merchant can be configured to be used only by a single user. Alternatively, the merchant identification card 203 from the online merchant can be configured to be used by a plurality of users.

The user can select products to be purchased, as shown in step 502. The use can user a shopping cart to gather products to be purchased and to bring the products to the checkout counter of the store.

The products to be purchased can be scanned, as shown in step 503. The products can be scanned by a checkout clerk at a traditional checkout counter. The products can be scanned by the user at a self-checkout counter. The products can be scanned by the user, such as by using the mobile device 120, and information from the scan can be communicated from the mobile device 120 to the merchant device 110, such as via WiFi, WiMax, infrared (IR), Bluetooth, or any other method.

The user can swipe the merchant's merchant identification card 203 with the mobile device 120, as shown in step 504. Swiping the merchant receiving card 203 can start the app 124. The checkout clerk can hand the merchant identification card 203 to the user so that the user can swipe the merchant identification card 203. In this manner, the checkout clerk can monitor and maintain some degree of control over the merchant identification card 203. The merchant identification card 203 can be tethered, such as by a chain or cord, to the checkout counter or proximate thereto.

The checkout clerk can swipe the merchant identification card 203. For example, the checkout clerk can swipe the merchant identification card 203 using the mobile device 120 of the user. Alternatively, the checkout clerk can swipe the merchant identification card 203 using the merchant device 110 and the merchant device 110 can communicate information relating to swiping of the merchant identification card 203 to the mobile device 120 such that the mobile device 120 has the information that it would have gotten from swiping the merchant identification card 203.

The app 124 of the mobile device 120 can request entry of the total amount required to pay for the purchase, as shown in step 505. In response to this request, the user or the checkout clerk can enter the total amount required to pay for the purchase into the mobile device 120, as shown in step 506. Alternatively, the merchant device 110 can communicate the total amount required to pay for the purchase to the mobile device 120, such as via WiFi, WiMax, infrared (IR), Bluetooth, or any other method. The app 124 of the mobile device 120 can request verification or acceptance by the user of the total amount, as shown in step 507. The user can verify the total amount, as shown in step 508.

The payment server 130 can process a transfer of the total amount from the user account 133 to the merchant account 134, as shown in step 509. In this manner, the merchant can be paid for the purchase of products made by the user.

FIG. 6 is a flow chart showing further detail of the method for customer payment processing, according to an embodiment. A memory can store account information of a user in a user account and can store account information of a merchant in a merchant account, as shown in step 601. One or more processors 131 can receive a first communication from the user including an indication of a desire of the user to pay for a product of the merchant and also including information from a merchant identification card of the merchant, as shown in step 602.

The processor(s) 131 can access the user account, as shown in step 603. The processor(s) 131 can determine, at least in part from the account information of the user, if the user is authorized to purchase the product, as shown in step 604.

The processor(s) 131 can authorize a payment transaction if the user is authorized to purchase the product, as shown in step 605. The payment server 130 can send a communication to the merchant device 110 and/or the mobile device 120 that is indicative of the payment transaction being authorized. For example, the payment server 130 can send an authorization code to the merchant device 110 and/or the mobile device 120.

As used herein, the term “store” can include any business or place of business. The store can be a brick and mortar store or an online store. The store can be any person or entity that sells a product.

As used herein, the terms “card” and “credit card” can refer to credit cards, bank cards, debit cards, gift cards, or any other cards that can be used to make a purchase.

As used herein, the term “merchant identification card” can refer to any card or other device that identifies a merchant. For example, the merchant identification card can be a credit card like item that has the merchant identification (ID), which can be a number, printed and/or embossed thereon and/or has the merchant ID stored on a magnetic strip thereof.

As used herein, the term “product” can include any item or service. Thus, the term “product” can refer to physical products, digital goods, services, or anything for which a user can make a payment, including charitable donations. A product can be anything that can be sold.

As used herein, the term “merchant” can include any seller of products. The term merchant can include a store. The products can be sold from a store or in any other manner.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “swiping” can include swiping, scanning, photographing or otherwise imaging, or any other way of reading a card, such as the merchant's merchant identification card. Such swiping can be done with a portable or hand held user device, such as a cellular telephone, having a card reader, camera, radio frequency identification (RFID) reader, bar code reader, quick response (QR) reader, or any other type of reader. Any decoding, such as of a bar code or QR code (which can be on the merchant's merchant identification card, for example) can be done by the mobile device, server, or elsewhere.

Thus, a user can purchase products without using cash and without undesirably disclosing personal information to a merchant and others. The user thus does not have to be concerned with unsolicited advertisements and/or other harm as a result of the purchase.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

1. A system comprising:
a memory storing account information of a user in a user account and storing account information of a merchant in a merchant account;
one or more processors operable to:
receive a first communication from the user including an indication of a desire of the user to pay for a product of the merchant and including information from a merchant identification card of the merchant;
access the user account;
determine, at least in part from the account information of the user, if the user is authorized to purchase the product; and
authorize a payment transaction if the user is authorized to purchase the product.

2. The system of claim 1, wherein the first communication is received from a mobile device of the user.

3. The system of claim 1, wherein the information from the merchant identification card includes an identification of the merchant.

4. The system of claim 1, wherein:
the information from the merchant identification card includes an identification of the merchant; and
the one or more processors are further operable to transfer money from the user account to the merchant account.

5. The system of claim 1, wherein the one or more processors are further operable to send a second communication to the merchant including an indication that the payment transaction has been completed.

6. The system of claim 1, wherein the one or more processors are further operable to send a second communication to the user including an indication that the payment transaction has been completed.

7. The system of claim 1, wherein the first communication includes a total price of the product.

8. A method comprising:
storing, in a memory, account information of a user in a user account and account information of a merchant in a merchant account;
receiving, electronically via one or more processors, a first communication from the user including an indication of a desire of the user to pay for a product of the merchant and including information from a merchant identification card of the merchant;
accessing, via the one or more processors, the user account;
determining, via the one or more processors, at least in part from the account information of the user, if the user is authorized to purchase the product; and
authorizing, via the one or more processors, a payment transaction if the user is authorized to purchase the product.

9. The method of claim 8, wherein the first communication is received from a mobile device of the user.

10. The method of claim 8, wherein the information from the merchant identification card includes an identification of the merchant.

11. The method of claim 8, wherein:
the information from the merchant identification card includes an identification of the merchant; and
further comprises transferring, via the one or more processors, money from the user account to the merchant account.

12. The method of claim 8, further comprising sending a second communication to the merchant including an indication that the payment transaction has been completed.

13. The method of claim 8, further comprising sending a second communication to the user including an indication that the payment transaction has been completed.

14. The method of claim 8, wherein the first communication includes a total price of the product.

15. A computer program product comprising a non-transitory computer readable medium having computer readable and executable code for instructing one or more processors to perform a method, the method comprising:
storing account information of a user in a user account and account information of a merchant in a merchant account;
receiving a first communication from the user including an indication of a desire of the user to pay for a product of the merchant and including information from a merchant identification card of the merchant;
accessing the user account;
determining, at least in part from the account information of the user, if the user is authorized to purchase the product; and
authorizing a payment transaction if the user is authorized to purchase the product.

16. The computer program product of claim 15, wherein the first communication is received from a mobile device of the user.

17. The computer program product of claim 15, wherein the information from the merchant identification card includes an identification of the merchant.

18. The computer program product of claim 15, wherein:
the information from the merchant identification card includes an identification of the merchant; and
wherein the method further comprises transferring money from the user account to the merchant account.

19. The computer program product of claim 15, wherein the method further comprises sending a second communication to the merchant including an indication that the payment transaction has been completed.

20. The computer program product of claim 15, wherein the method further comprises sending a second communication to the user including an indication that the payment transaction has been completed.

21. The computer program product of claim 15, wherein the first communication includes a total price of the product.
